(19) United States
(12) Patent Application Publication
(10) Pub. No.: US 2004/0267448 A1
(43) Pub. Date: Dec. 30, 2004

(54) Navigation system and location search method

(75) Inventors: Toshihiro Kano, Okazaki-shi (JP); Kunihiro Yamada, Okazaki-shi (JP); Satoshi Ogawa, Okazaki-shi (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 10/858,063

(22) Filed: Jun. 2, 2004

(30) Foreign Application Priority Data
Jun. 24, 2003 (JP) 2003-180146

(51) Int. Cl. G01C 21/34

(52) U.S. Cl. 701/209; 340/995.19

(57) ABSTRACT

A navigation system includes a current position detector that detects a current position and at least one controller. The at least one controller determines an administrative district where the current position is located, searches for at least one facility, each at least one facility located in a corresponding one of a plurality of administrative districts substantially adjacent to the administrative district where the current position is located, and assigns each of the plurality of administrative districts substantially adjacent to the administrative district where the current position is located to a selection area on a search screen based on a direction from the current position to one of the at least one facilities within that one of the plurality of administrative districts substantially adjacent to the administrative district where the current position is located.

The disclosure of Japanese Patent Application No. 2003-180146 filed on Jun. 24, 2004 including the specification, drawings and abstract are incorporated herein by reference in their entirety.

### BACKGROUND OF THE INVENTION

1. Field of Invention

The present invention relates to a navigation system and a method for implementing a location search.

2. Description of Related Art

In conventional vehicle navigation apparatus, the current position of a vehicle is detected by, for example, a global positioning system (GPS). The running direction of the vehicle is detected by detecting the turning angle of the vehicle using a gyroscopic sensor. Furthermore, map data is read from a data storage unit, and a map indicating a nearby area in which the vehicle is running is displayed on a display screen. On the map, the current position and the running direction of the vehicle are also displayed. A user or a driver can drive the vehicle in accordance with the current position, the running direction of the vehicle, and the map displayed on the map screen.

If the user sets a destination and specifies a searching condition, a route from the current position to the destination is searched for in accordance with the specified searching condition. The route resulting from the searching is displayed together with the current position and the destination on a route display screen of the display. Thus, a driver can drive the vehicle in accordance with the route displayed on the screen. When a location different from the current position is specified as the starting point by the driver, a route from the specified starting point to the destination is searched for.

When a destination is set or a particular location is registered in a memory, a user can search for a desired location by specifying an address. To this end, a searching screen is displayed on the display of the vehicle navigation apparatus, and addresses are displayed in the form of a list on the searching screen (refer to, for example, Japanese Unexamined Patent Application Publication No. 9-292831).

If the driver selects one of the addresses from the list by performing an operation on an operation control unit, the location corresponding to the selected address is searched for. The driver may also specify a desired address by inputting characters indicating the address. In that case, the location corresponding to the specified address is searched for.

### SUMMARY OF THE INVENTION

In the conventional vehicle navigation apparatus described above, information indicating the relative positional relationship between the current position and a location to search for is not given, and the lack of such information causes a difficulty in searching for the location.

Thus, various exemplary embodiments of this invention provide a navigation system and a location search program capable of easily searching for a location by an address by at least providing the relative positional relationship between the location and address.

Various exemplary embodiments of this invention provide a navigation system, including a current position detector that detects a current position and at least one controller. The at least one controller determines an administrative district where the current position is located, searches for at least one facility, each at least one facility located in a corresponding one of a plurality of administrative districts substantially adjacent to the administrative district where the current position is located, and assigns each of the plurality of administrative districts substantially adjacent to the administrative district where the current position is located to a selection area on a search screen based on a direction from the current position to one of the at least one facilities within that one of the plurality of administrative districts substantially adjacent to the administrative district where the current position is located.

Various exemplary embodiments of this invention provide a method for searching for a location, including determining a current position, searching for at least one facility, each at least one facility located in a corresponding one of a plurality of administrative districts substantially adjacent to the administrative district where the current position is located, and assigning each of the plurality of administrative districts substantially adjacent to the administrative district where the current position is located to a selection area on a search screen based on a direction from the current position to one of the at least one facilities within that one of the plurality of administrative districts substantially adjacent to the administrative district where the current position is located.

### BRIEF DESCRIPTION OF THE DRAWINGS

Exemplary embodiments of the invention will now be described with reference to the accompanying drawings, wherein:

FIG. 1 is a diagram showing a navigation system according to a first exemplary embodiment of the invention;

FIG. 2 is a flow chart showing a searching operation according to the first exemplary embodiment of the invention;

FIG. 3 is a first diagram showing an example of a search screen used in a wide-area search according to the first exemplary embodiment of the invention;

FIG. 4 is a second diagram showing an example of a search screen used in a wide-area search according to the first exemplary embodiment of the invention;

FIG. 5 is a third diagram showing an example of a search screen used in a wide-area search according to the first exemplary embodiment of the invention;

FIG. 6 is a conceptual diagram showing locations of cities, towns, and villages, according to the first exemplary embodiment of the invention;

FIG. 7 is a diagram showing an example of a search screen used in a narrow-area search according to the first exemplary embodiment of the invention;

FIG. 8 is a diagram showing a button assignment process according to the first exemplary embodiment of the invention;

FIG. 9 is a flow chart showing a searching operation according to a second exemplary embodiment of the invention;

FIG. 10 is a conceptual diagram showing locations of cities, towns, and villages, according to the second exemplary embodiment of the invention;

FIG. 11 is a first diagram showing a button assignment process according to the second exemplary embodiment of the invention;

FIG. 12 is a diagram showing an example of a search screen used in a small-area search according to the second exemplary embodiment of the invention; and

FIG. 13 is a second diagram showing a button assignment process according to the second exemplary embodiment of the invention.

### DETAILED DESCRIPTION OF EXEMPLARY EMBODIMENTS

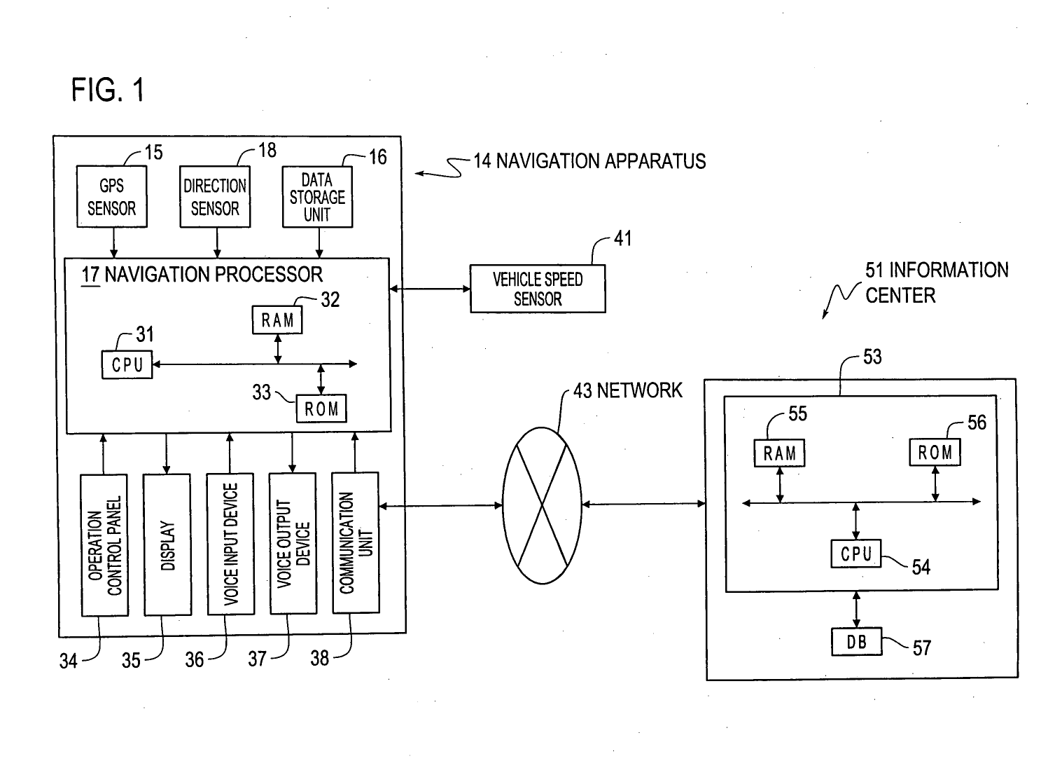

FIG. 1 is a diagram showing a navigation system according to the first exemplary embodiment of the invention. As shown in FIG. 1, an information terminal 14 such as a vehicle navigation apparatus may be installed on a vehicle. The vehicle navigation apparatus 14 can include a GPS sensor 15 serving as a current position detector for detecting a current position, a data storage unit 16 serving as an information storage unit for storing navigation information such as map data, road data, and search data that are basic information used in the vehicle navigation apparatus 14 and additional various kinds of information. The navigation apparatus 14 may also include a navigation processing unit 17 formed of a computer operating in accordance with programs and data for performing various operations including navigation processing in accordance with input information, a direction sensor 18 serving as a direction detector for detecting the direction of the vehicle.

The navigation apparatus 14 may include an operation control unit 34 serving as a first input unit for use by an operator or a driver to input a command or data, a display 35 serving as a first output unit for displaying various kinds of information in the form of images on a screen (not shown), an audio input unit 36 serving as a second input unit for inputting an audible command or data, an audio output unit 37 serving as a second output unit for outputting audible information, for example, in the form of a voice informing the driver of navigation information, and a communication unit 38 serving as a communication unit that can include a transmitter/receiver. The operation control unit 34, the display 35, the audio input unit 36, the audio output unit 37, and the communication unit 38 may be connected to the navigation processing unit 17. A vehicle speed sensor 41 serving as a vehicle speed detector may also connected with the navigation processing unit 17.

The GPS sensor 15 receives radio waves transmitted from satellites and detects the current position on the ground from the received radio waves. The GPS sensor 15 can also detect a current time from the received radio waves.

Although the GPS sensor 15 may be used as a current position detector, one or more of a distance sensor, a steering sensor, or an altimeter may be used as a current position detector. The distance sensor detects the distance between two points on a road on the basis of the rotation speed of wheels (not shown) or on the basis of a value obtained by integrating the acceleration twice. The steering sensor detects the steering angle by using, for example, an optical rotation sensor (not shown) disposed on a rotating part of a steering wheel, a rotational resistance sensor, or an angle sensor disposed on a wheel.

A gyroscopic sensor or a geomagnetic sensor may be used as the direction sensor 18. The gyroscopic sensor detects the direction of the vehicle by integrating the angle of traverse. For example, a gas rate gyroscope or a vibrating gyroscope may be used as the gyroscopic sensor. The geomagnetic sensor detects the direction of the vehicle by detecting the geomagnetism.

The data storage unit 16 can store a database that may include data files such as a map data file, an intersection data file, a node data file, a road data file, a route search data file, a facility information data file, and a location search data file. In each of those data files, data used in outputting various images to the display 35 is stored. In the data storage unit 16, data used in outputting information via the audio output unit 37 is also stored.

Map data used to display a map is stored in the map data file. Intersection data associated with intersections is stored in the intersection data file. Node data associated with nodes is stored in the node data file. Road data associated with roads is stored in the road data file. Route search data used in searching for a route is stored in the route search data file. Facility information data associated with facilities is stored in the facility information data file. Location search data used in searching for locations is stored in the location search data file. The intersection data, the node data, the road data, and the route search data form road status data indicating road status.

The intersection data may include data indicating intersection names, intersection shapes, facilities located adjacent to an intersection, and names of places close to intersections. The node data includes data indicating actual branch points (including intersections and T junctions), nodes, and links between adjacent nodes of roads.

The road data may include data indicating road structures such as width, gradient, cant, bank, road surface state, the number of lanes, point at which the number of lanes decreases, and point at which the width decreases, corner data indicating curvature radius, intersection, T junction, and comer entrance, road attribute data indicating whether a road of interest is a downhill road or an uphill road, road type data indicating road type such as general road (national road, prefectural road, narrow street, etc.), expressway, urban expressway, and toll road. The road data also includes data indicating railroad crossings, expressway entrance/exit rampways, and tollgates of expressways or toll roads. The facility information data may include data indicating names, addresses, telephone numbers, and other information about facilities such as hotels, gas stations, parking lots resorts, and department stores.

The navigation processing unit 17 can include a CPU 31 serving as a processor or a controller responsible for control over the entire vehicle navigation apparatus 14, a RAM 32 serving as a storage medium, such as, for example, a DRAM, SRAM, MRAM, or FRAM, used as a working memory in processing performed by the CPU 31, a ROM 33 serving as a storage medium and may store a control program and other programs such as a route search program and a route guidance program, and a flash memory (not shown) that may serve as a storage medium for storing various kinds of data and programs. Semiconductor memories or magnetic cores may also be used as internal storage devices such as the RAM 32, the ROM 33, and the flash memory.

An MPU may be used instead of the CPU 31 serving as the processor or the controller.

The data storage unit 16 for storing various kinds of data can include an external storage device, a magnetic disk such as a hard disk or a flexible disk used as a storage medium (not shown), and a read/write head (not shown) for reading/writing data. As for the storage medium for the external storage device used as the data storage unit 16, a magnetic tape, a magnetic drum, a CD, an MD, a DVD, an optical disk, an MO, an IC card, or an optical card may also be employed.

Instead of storing programs in the ROM 33 and storing data in the data storage unit 16, the programs and data may be stored on the hard disk or the like. In this case, the programs and the data may be read from the hard disk device into the flash memory. It is possible to update the program and/or the data by exchanging the hard disk or the like. If an automatic transmission controller for controlling an automatic transmission (not shown) is installed in the vehicle, a program and data used to control the automatic transmission may also be stored on the hard disk or the like. The program and/or the data may be received via the communication unit 38 and may be stored in the flash memory.

The operation control unit 34 may be used by a user to, for example, change the current position from which to start driving, input a start point and a destination point, input a waypoint, or control the communication unit 38. The operation control unit 34 may include a keyboard, a mouse, a bar code reader, a light pen, a remote controller, or a joy stick, which is disposed separately from the display 35. The operation control unit 34 may include various keys, switches, and/or buttons in the form of virtual keys displayed on a touch screen of the display 35 so that commands and/or data can be input by touching or clicking on those virtual keys.

As for the display 35, a CRT display, a liquid crystal display, or a plasma display may be used. Alternatively, the display 35 may include a holographic device for forming an image by projecting a holographic image onto front glass of the vehicle. It is possible to display various kinds of information on the screen of the display 35, such as the current position, a map, a route selected via searching, navigation information along the selected route, and traffic information. A photograph or a simplified diagram may also be displayed on the screen of the display 35 to indicate a feature of an intersection or a route, the distance to a next intersection, the traffic structure of the next intersection, and other associated information. Furthermore, information indicating how to use virtual keys, the operation control unit 34, and/or the audio input unit 36, operation menus, information indicating-what keys are available, and/or a FM multiplex broadcast program table may also be displayed.

The audio input unit 36 may include a microphone or the like (not shown) and is used to input necessary information by means of, for example, a voice. The audio output unit 37 may include a voice synthesizer and a speaker (not shown) whereby a synthesized voice indicating various kinds of information such as route navigation information, guidance information, and traffic information are output from the audio output unit 37. Instead of or in addition to voices synthesized by the voice synthesizer, various other sounds and/or voices indicating various kinds of information may be stored in a memory or a magnetic storage device such as a magnetic tape storage device and may be output from the audio output unit 37.

The communication unit 38 may include a beacon receiver for receiving various kinds of information transmitted in the form of radio beacon signals or light beacon signals from an information provider such as the VICS® (Vehicle Information and Communication System) via radio beacon transmitters or light beacon transmitters disposed along roads. The communication unit 38 also includes a FM receiver for receiving various kinds of information transmitted in the form of FM multiplex broadcasting via FM broadcast stations. Specifically, the beacon receiver may be used to receive traffic information such as road congestion information, traffic restriction information, parking lot information, traffic accident information, and service area congestion information. The FM receiver may be used to receive, in addition to the traffic information described above, general information such as news and weather forecasts via FM multiplex broadcasting. Although in the present exemplary embodiment, the beacon receiver and the FM receiver are integrated in the VICS receiver, they may also be disposed separately.

The communication unit 38 is also capable of receiving other various kinds of data from particular base stations, such as D-GPS information used to detect a detection error of the GPS sensor 15. Furthermore, the communication unit 38 is capable of receiving position information via a radio beacon or a light beacon thereby detecting the current position. In this case, the beacon receiver can also serve as the current position detector.

The communication unit 38 is capable of receiving various kinds of information such as traffic information and other general information from the information center 51 serving as an information provider. To this end, the communication unit 38 may be connected to the information center 51 via a network 43.

The vehicle navigation apparatus 14, the information center 51, and the network 43 form a navigation system in which various kinds of information may be transmitted between the communication unit 38 and a communication unit (not shown) of the information center 5 1.

In the present exemplary embodiment, in order to make it possible for the communication unit 38 to communicate, a communication device such as, for example, a portable telephone module may be disposed in the communication unit 38. Alternatively, a communication device may be disposed separately from the communication unit 38 and the communication device may be connected with the communication unit 38. In this case, a mobile telephone such as a cellular telephone, a car telephone, or a PHS telephone, or a wireless LAN card may be used as the communication device. A personal computer, a portable computer, a personal digital assistance (PDA) device, an electronic notepad, a video telephone, a game machine or the like may also be used as the communication device if the device has communication capability.

As the network 43, a communication network such as, for example, a LAN (Local Area Network), a WAN (Wide Area Network), an intranet, a portable telephone network, a telephone network, a public communication network, a private communication network, or the Internet may be used. A communication line using a communication system such as CS broadcasting or BS broadcasting using a satellite, terrestrial digital broadcasting, or FM multiplex broadcasting, or a communication line using a non-stop automatic toll collection system (ETC, Electronic Toll Collection system) used in an intelligent traffic system (ITS) or a dedicated short range communication (DSRC) system may also be used as the network 43.

The information center 51 may be operated by an individual, a company, an organization, a local government, or a government-affiliated organization. For example, the information center 51 may be operated by the VICS®.

The information center 51 can include a server 53, a database (DB) 57 serving as an information storage unit connected with the server 53, and the communication unit. The communication unit allows two-way communication between the information center 51 and the vehicle navigation apparatus 14 whereby traffic information and general information are supplied. To this end, the server 53 includes a CPU 54 serving as a processor or a controller, a RAM 55, and ROM 56, thus forming a computer that operates in accordance with a specific program and data. Various kinds of data (including navigation information) similar to the data stored in the data storage unit 16 may be stored in the database 57. The computer may be formed by the server 53 and the navigation processing unit 17. Instead of the CPU 54, a MPU may be used.

If information such as traffic information or general information is received from the road traffic information center, the CPU 54 can directly store the received information as raw information in the database 57 or can store the information as secondary information in the database 57 after performing statistical processing on the information to produce statistical data. Such statistical data can include history information indicating the history of traffic congestion or predicted traffic congestion information. In the present exemplary embodiment, when the statistical data is produced, the history information may be processed according to detailed conditions in terms of the date/time, days of the week, weather, events, seasons, facility information (indicating whether there is a large-scale facility such as a department store or a super market).

The basic operation of the navigation system formed in the above-described manner is described below.

If a user activates the vehicle navigation apparatus 14 by operating the operation control unit 34, the CPU 31 initializes various data and reads data indicating the current position detected by the GPS sensor 15 and the vehicle direction detected by the direction sensor 18. The CPU 31 may include a matching processing unit (not shown). The matching processing unit performs matching processing on the basis of the trajectory of the current position obtained from the stored data and the shapes and locations of road links of nearby roads, and the matching processing unit detects the road link on which the current position is located thereby identifying the current position.

The CPU 31 also acquires navigation information by reading it from the data storage unit 16 or by receiving it from the information center 51 via the communication unit 38. In the case in which the navigation information is acquired from the information center 51, the CPU 31 downloads navigation information into the flash memory or the hard disk. When navigation information is acquired via the communication unit 38, programs may also be acquired in addition to the navigation information.

The CPU 31 further forms a map screen on the display 35 and displays the current position, a map of a nearby area around the current position, and the direction of the vehicle on the map screen. A driver can drive the vehicle in accordance with the current position, the map of the nearby area around the current position, and the direction of the vehicle.

The vehicle navigation apparatus 14 or the navigation system may be used to search for a route, as described below.

If a user inputs a destination by operating the operation control unit 34, the CPU 31 performs a destination setting process to set the destination. If necessary, a start point may be input and set. One or more points may also be registered in advance, and the start point may be selected from the registered points.

If the destination is set, the CPU 31 performs a route search process. The CPU 31 reads data indicating the current position and the destination and also reads search data from the data storage unit 16. The CPU 31 searches for a route from the start point given by the current position to the destination on the basis of the current position, the destination, and the search data and outputs search data indicating the determined route.

Thereafter, the CPU 31 performs a guidance process. Specifically, the CPU 31 provides route guidance information along the route to the driver. To this end, the CPU 31 reads the route data and displays the route on the map screen in accordance with the route data.

If necessary, the CPU 31 performs an audio output process. Specifically, the CPU 31 outputs an audio signal indicating navigation information associated with the route via the audio output unit 37.

When a destination is set or a particular location is registered in the memory, a user may search for a desired location by an address, as described below. To this end, the CPU 31 performs a search process to search for a particular location in accordance with an address input by a user by operating the operation control unit.

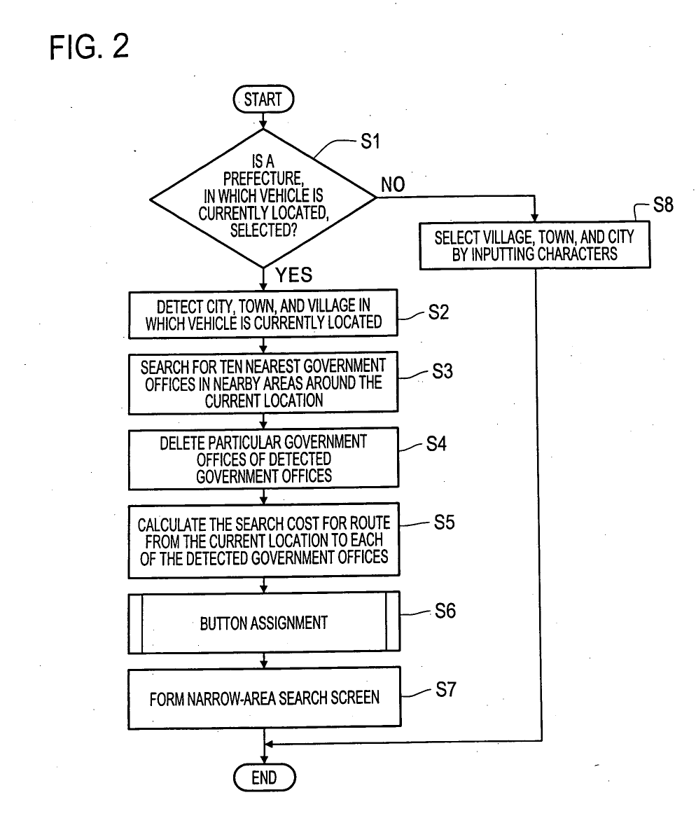

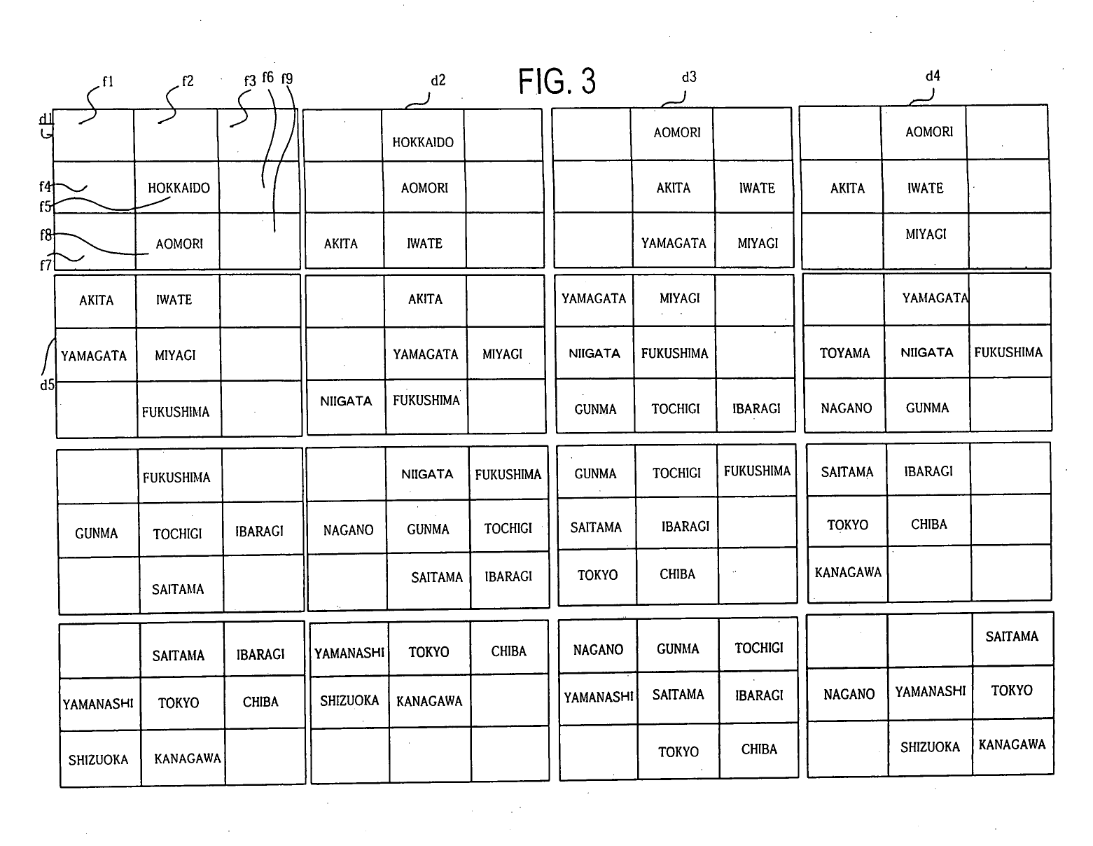

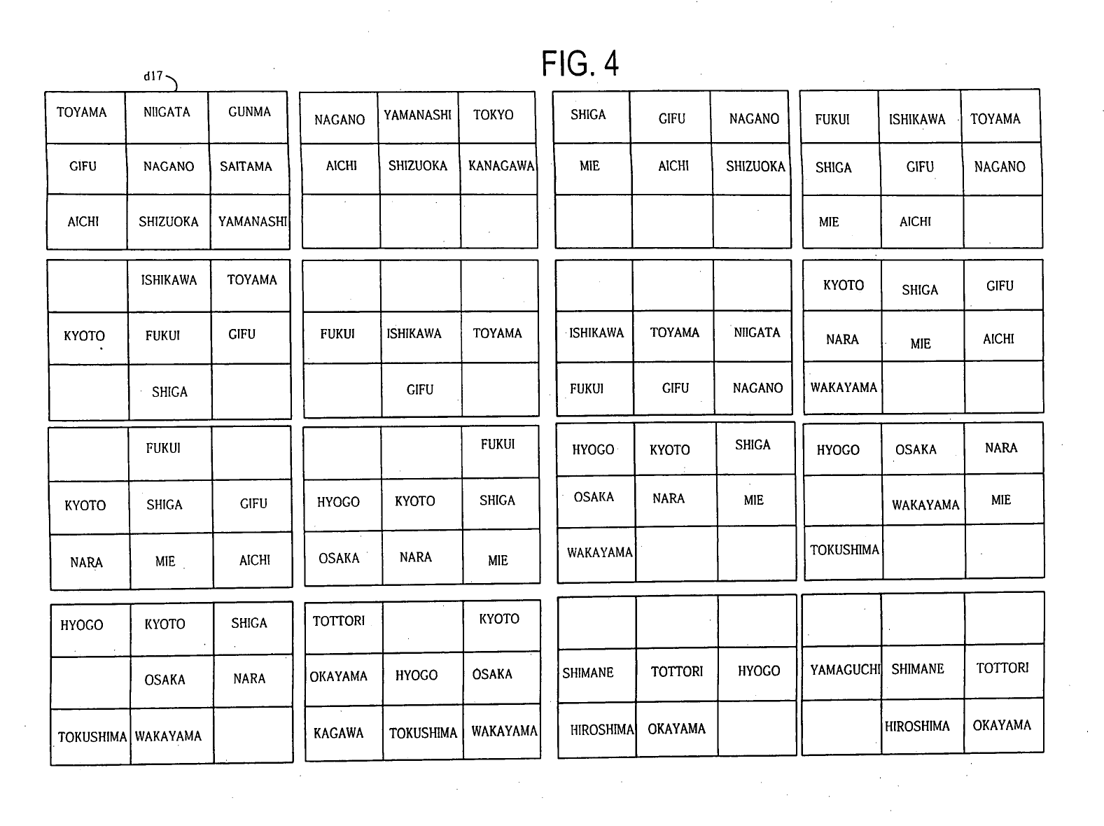

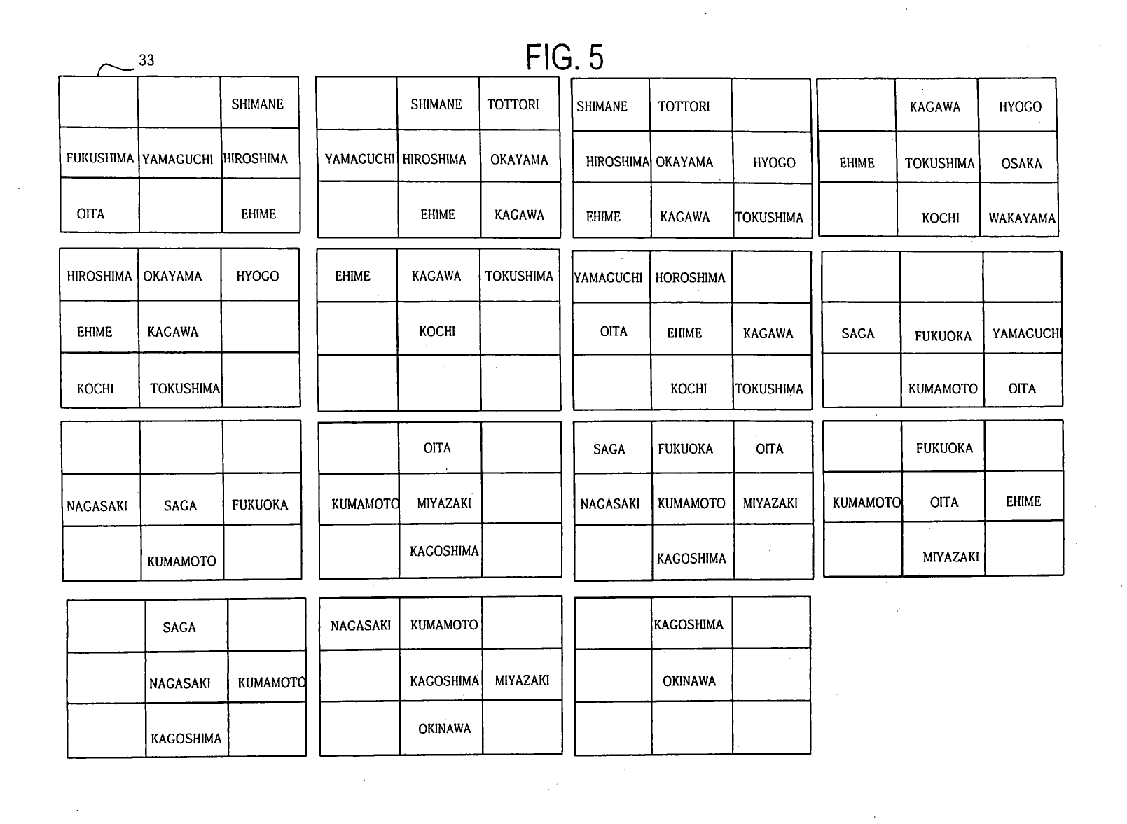

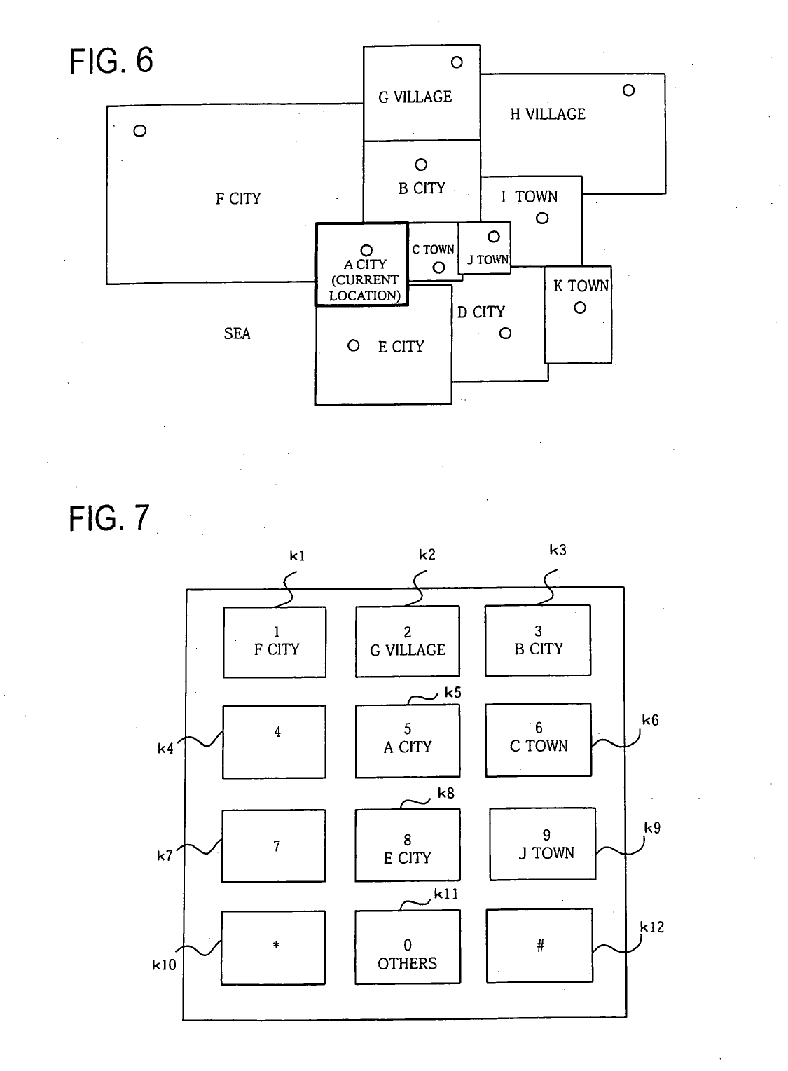

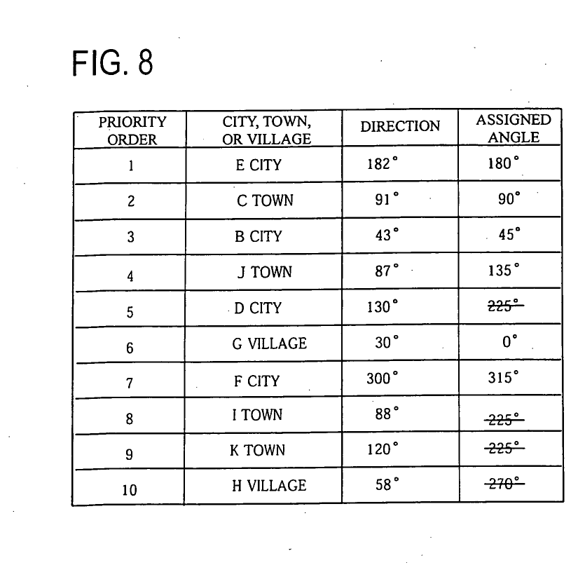

The operation of the search means is described in further detail with reference to FIGS. 2-8. FIG. 2 is a flow chart showing a searching operation according to the first exemplary embodiment of the invention. FIG. 3 is a first diagram showing an example of a search screen used in a wide-area search according to the first exemplary embodiment of the invention. FIG. 4 is a second diagram showing an example of a search screen used in a wide-area search according to the first exemplary embodiment of the invention. FIG. 5 is a third diagram showing an example of a search screen used in a wide-area search according to the first exemplary embodiment of the invention. FIG. 6 is a conceptual diagram showing actual locations of cities, towns, and villages, according to the first exemplary embodiment of the invention. FIG. 7 is a diagram showing an example of a search screen used in a narrow-area search according to the first exemplary embodiment of the invention. FIG. 8 is a diagram showing a button assignment process according to the first exemplary embodiment of the invention.

First, the user operates the operation control unit 34 (FIG. 1) such that the driver touches a location search key on the initial screen of the display 35 to start searching for a location by an address. In response, the CPU 31 performs a search screen display process. Specifically, the CPU 31 forms a wide-area search screen di (i=1, 2, . . . ), such as that shown in FIGS. 3 to 5, on the display 35, in accordance with the data stored in the search data file. The search screen di is used to select an administrative district or a wide administrative district such as Tokyo, Hokkaido, Osaka-fu, Kyoto-fu, or any prefecture (hereinafter generically referred to as a prefecture). The search screen di includes a plurality of rectangular selection areas fj (j=1, 2, . . . ) arranged in the form of a matrix array (a 3×3 matrix array in this specific example). In the initial state, the name of a prefecture in which the vehicle is currently located is displayed in the selection area fj (the selection area f5 in this specific embodiment) in the center of the search screen di, and the names of prefectures adjacent to the prefecture in which the vehicle is currently located are displayed in selection areas fj (selections areas f1 to f4 and f6 to f9 in this specific embodiment) around the central selection area fj. For the above purpose, data used to set prefecture names in the respective selection areas fj may be stored as search data in the search data file.

Herein, a prefecture in which the vehicle is currently located is referred to as a currently-located wide administrative district, and prefectures adjacent to the prefecture in which the vehicle is currently located are referred to as adjacent wide administrative districts.

In the present exemplary embodiment, each selection area fj is disposed at a location corresponding to-the location of the prefecture on a map. As a result, the relationship in terms of location among selection areas fj in the search screen di becomes similar to the relationship in terms of location among the actual prefectures. In a case in which there is no prefecture adjacent in a particular direction to a prefecture, but the prefecture faces a sea in that direction, no prefecture name is displayed in the corresponding selection area fj.

If the user touches the search screen di at a particular selection area fj to select the prefecture whose name is displayed in that selection area fj, the CPU 31 performs a wide-area search process to set the selected prefecture as a selected wide area.

The search screen di can be scrolled by using a scroll key (not shown). For example, if the search screen d1 is scrolled to right, a search screen d2 appears. If the search screen d1 is scrolled down, a search screen d5 appears. That is, names of prefectures displayed in the respective selection areas change in response to scrolling.

The CPU 31 then determines whether a prefecture in which the vehicle is currently located has been selected (step S1). If it is determined that a prefecture in which the vehicle is currently located is not selected (S1=NO), a screen for use in inputting characters is formed on the display 35. In response, the user specifies a wide administrative district and a small administrate district by inputting characters indicating a city, a town, and/or a village (step S8).

If a prefecture in which the vehicle is currently located is selected (S1=YES), the CPU 31 performs an administrative district detection process to detect a city, a town, or a village (A city, in this specific example) in which the vehicle is currently located (step S2). Subsequently, the CPU 31 performs a specific facility search process. Specifically, the CPU 31 reads facility data and data indicating the current position, and searches for specific facilities that are located in areas adjacent to the current position and that are useful to identify cities, towns, and/or villages (step S3). In the present embodiment, the specific facilities include administrative institution offices (prefectural government offices, city government offices, town government offices, village government offices, etc.), and the searching for specific facilities is performed on the basis of coordinates of the current location and coordinates of facilities such that, for example, ten specific facilities that are closest in linear distance to the current position are selected in the order of increasing linear distance.

As for the specific facilities, it is desirable to select specific facilities that can be found without fail in respective cities, towns, and/or villages (B city, C town, D city, E city, F city, G village, H village, I town, J town, and K town, in this specific example) adjacent to a city, a town, or a village in which the vehicle is currently located (hereinafter, such adjacent cities, towns, and/or villages will be referred to simply as “adjacent cities, town, and/or villages”) and that are located in central areas of the respective adjacent cities, towns, and/or villages. It is desirable that the number of such specific facilities-located in each city, town, or village be as small as possible, although at least one specific facility must be present in each city, town, or village. In view of the above, administrative institution offices (denoted by open circles in FIG. 6) are selected as the specific facilities. Although gas stations, convenience stores, or boundaries on main roads between cities, towns, or villages may be selected as the specific facilities instead of administrative institution offices. However, there are many such non-administrative specific facilities and thus the processing time and cost of computation performed by the CPU 31 will increase.

Subsequently, the CPU 31 performs a specific facility selection process. Specifically, particular administrative institution offices of the detected administrative institution offices, for example, an administrative institution office (prefectural government office) of a prefecture in which the vehicle is currently located, an administrative institution office (a city government office, a town government office, or a village government office) of a city, a town, or a village in which the vehicle is currently located, and/or other administrative institution offices in prefectures (prefectural government offices, city government offices, town government offices, and/or village government offices) are deleted (no administrative institution offices are deleted in this specific example) (step S4). Thus, the CPU 31 selects remaining administrative institution offices located in adjacent cities, towns, and/or villages.

Thereafter, the CPU 31 performs a specific facility evaluation process in which, on the basis of the coordinates of the current position and the coordinates of the respective administrative institution offices, the search cost of a route from the current position to each of the selected administrative institution offices is calculated (step S5). Each administrative institution office is evaluated by using the calculated search cost as an evaluation measure. Specifically, the CPU 31 reads the search data and determines a route from the current position to each administrative institution office. Thereafter, the CPU 31 calculates the cost for each route on the basis of a predetermined cost condition (the distance in the present embodiment), and employs the calculated cost as the search cost.

Next, the CPU 31 performs a button assignment process as a selection area assignment process in which buttons k1 to k12 similar to telephone push buttons indicating “1” to “9”, “*”, “0”, and “#” are displayed on the narrow-area search screen as shown in FIG. 7, and buttons k1 to k9 are assigned as selection areas for selecting cities, towns, and/or villages on the basis of the search cost of the route to each administrative institution office (step S6).

Specifically, the CPU 31 performs an order determination process in which cities, towns, and/or villages corresponding to the ten selected administrative institution offices are sorted in the order of decreasing evaluation score obtained in the evaluation starting from a highest evaluation score, as shown in FIG. 8 (in this specific example, cities, towns, and villages are sorted into the order of E city, C town, B city, J town, D city, G village, F city, I town, K town, and H village).

Thereafter, the CPU 31 performs a direction calculation process. Specifically, the direction αi (i=1, 2, . . . , 10) from the current position to each administrative institution office is calculated from the coordinates of the current position and the coordinates of each administrative institution office. In this process, the direction αi is expressed by an angle measured in a clockwise direction with respect to due north. In this specific example, the directions αi of E city, C town, B city, J town, D city, G village, F city, I town, K town, and H village are respectively calculated as 182, 91, 43, 87, 130, 30, 300, 88, 120, and 58 (in units of degrees).

According to the present exemplary embodiment, a button k5 is assigned to represent a city, a town, or a village in which the vehicle is currently located, and eight buttons k1 to k4 and k6 to k9 are assigned to represent adjacent cities, towns, and/or villages. The buttons k1 to k4 and k6 to k9 respectively have assigned angles βi (i=1, 2, . . . , 10) 0, 45, 90, 135, 180, 225, 270, and 315 (in units of degrees) indicating the positions of the respective buttons k1 to k4 and k6 to k9, wherein each direction βi is expressed by an angle measured in a clockwise direction with respect to due north.

Furthermore, the CPU 31 performs an assignment process such that an assigned angle pi closest to the angle αi calculated in the angle calculation process is determined, and a button having the determined assigned angle βi is assigned. If any assigned angle βi is employed once, the same assigned angle βi is not used again, and an assigned angle βi closest to a next given direction αi is selected from the remaining assigned angles βi.

The assignment means calculates the absolute angle difference Δγi (i=1, 2, . . . , 10) between the direction αi and the assigned angle βi, as shown below.

Δγi=αi−βi (1)

If this angle difference Δγi is equal to or greater than a threshold value γth (for example, 90°), the assigned angle βi is revoked and no button is assigned.

More specifically, in this specific example, the angle α1 of E city is 182°, and thus an assigned angle β1 of 180° closest to the angle of 182° is employed, and a button k8 is assigned to represent E city. On the other hand, the angle α2 of C town is 91°, and thus an assigned angle β2 of 90° closest to the angle of 91° is employed, and a button k6 is assigned to represent C town. The angle α3 of B city is 43°, and thus an assigned angle β3 of 45° closest to the angle of 43° is employed, and a button k3 is assigned to represent B city. The angle α4 of J town is 87°, and thus an assigned angle β4 of 135° closest to the angle of 87° is employed, and a button k9 is assigned to represent J town. In this case, although the assigned angle β2 of 90° is closer than the assigned angle of β4 of 135° to the angle of 87°, the assigned angle β2 of 90° has already been used for C town. Thus, the assigned angle β4 of 135° that is closest, of the remaining assigned angle, to the angle of 87° is employed.

The angle α5 of D city is 130°, and thus an assigned angle β5 of 225° is closest to the angle of 130°. However, in this case, the angle difference Δγ5=|130−225|=95°, and thus the angle difference Δγ5 is greater than the threshold value γth. Therefore, the assigned angle β5 is revoked, and no button representing D city is assigned. The angle α6 of G village is 30°, and thus an assigned angle β6 of 0° closest to the angle of 30° is employed, and a button k2 is assigned to represent G village.

The angle α7 of F city is 300°, and thus an assigned angle β7 of 315° closest to the angle of 300° is employed, and a button k1 is assigned to represent F city. The angle α8 of I town is 88°, and thus an assigned angle β8 of 225° is closest to the angle of 88°. However, in this case, the angle difference Δγ8=|88−225|=137°, and thus the angle difference Δγ8 is greater than the threshold value γth. Therefore, the assigned angle β8 is revoked, and no button for representing D city is assigned.

The angle α9 of K town is 120°, and thus an assigned angle β9 of 225° is closest to the angle of 120°. However, in this case, the angle difference Δγ9=|120−225|=105°, and thus the angle difference Δγ9 is greater than the threshold value γth. Therefore, the assigned angle β9 is revoked, and no button for representing K town is assigned. The angle α10 of H village is 58°, and thus an assigned angle β10 of 270° is closest to the angle of 58°. However, in this case, the angle difference Δγ10=360−(|270−58|)=148°, and thus the angle difference Δγ10 is greater than the threshold value γth. Therefore, the assigned angle β10 is revoked, and no button for representing H village is assigned. Note that when the angle difference according to equation (1) is greater than 180°, the conjugate angle (360°—the angle difference) is used. Also note that the sea in FIG. 6 is assigned buttons k4 and k7.

If assignment of buttons to the respective cities, towns, and/or villages is completed, the CPU 31 forms a narrow-area search screen on the display 35 as shown in FIG. 7 (step S7).

In this state, the user can select one of cities, towns, and/or villages whose name is displayed on corresponding buttons k1 to k9, by touching one of buttons k1 to k9 displayed on the search screen. If one of the cities, towns, and/or villages is selected, the CPU 31 performs a narrow-area search process to set the city, town, or village, selected in the previous process, as a selected narrow area. If a remote controller is used as the operation control unit 34, one of cities, towns, and/or villages whose name is displayed on corresponding buttons k1 to k9 may be selected by pressing an arrow key or a numeric key of the remote controller.

As described above, the buttons k1 to k9 on the search screen are assigned to cities, towns, and/or villages such that the positional relationship among the buttons k1 to k9 is similar to the actual positional relationship between a city, a town, or a village in which the vehicle is currently located and adjacent cities, towns, and/or villages. Thus, the driver can easily recognize the positional relationship between the current position and a location to search for. This makes it possible to easily search for a location by an address.

Furthermore, because the buttons k1 to k9 for selecting a city, a town, or a village are laid out on the search screen in a similar manner to the manner in which telephone push buttons are laid out, it becomes possible to easily operate the operation control unit 34.

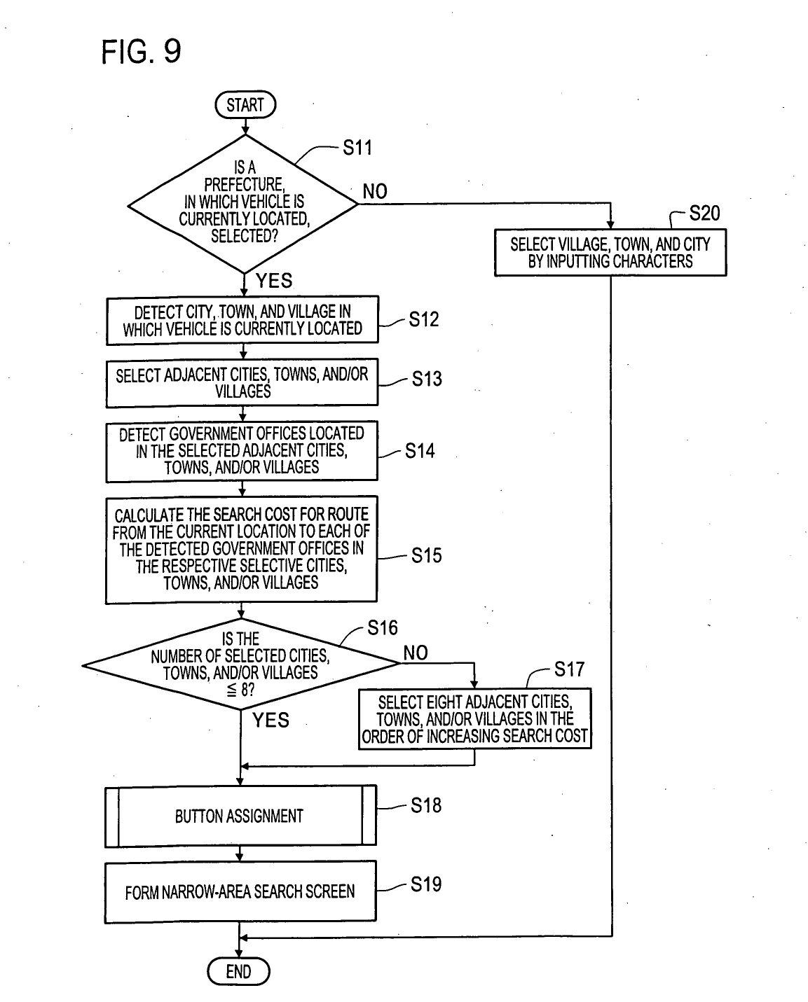

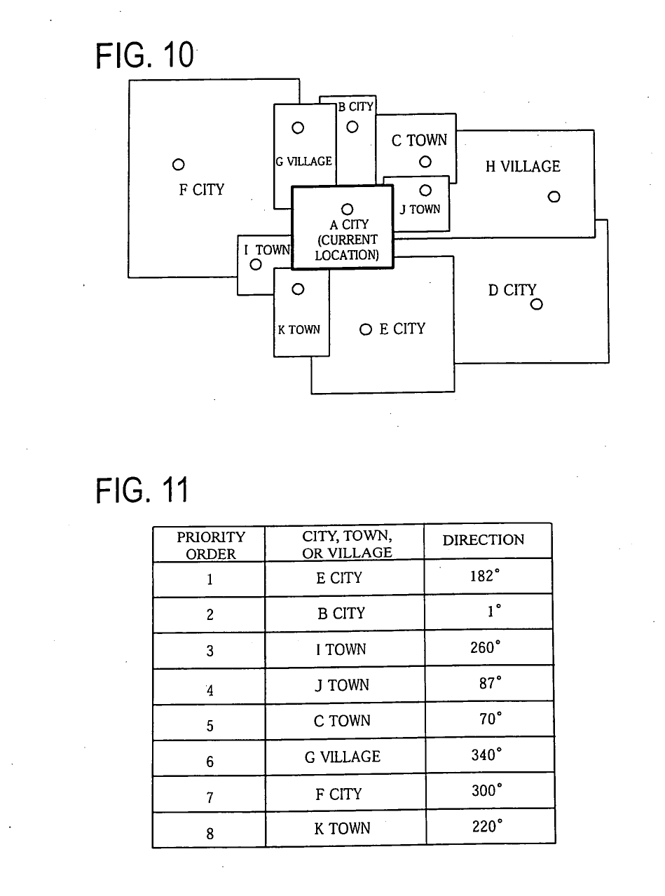

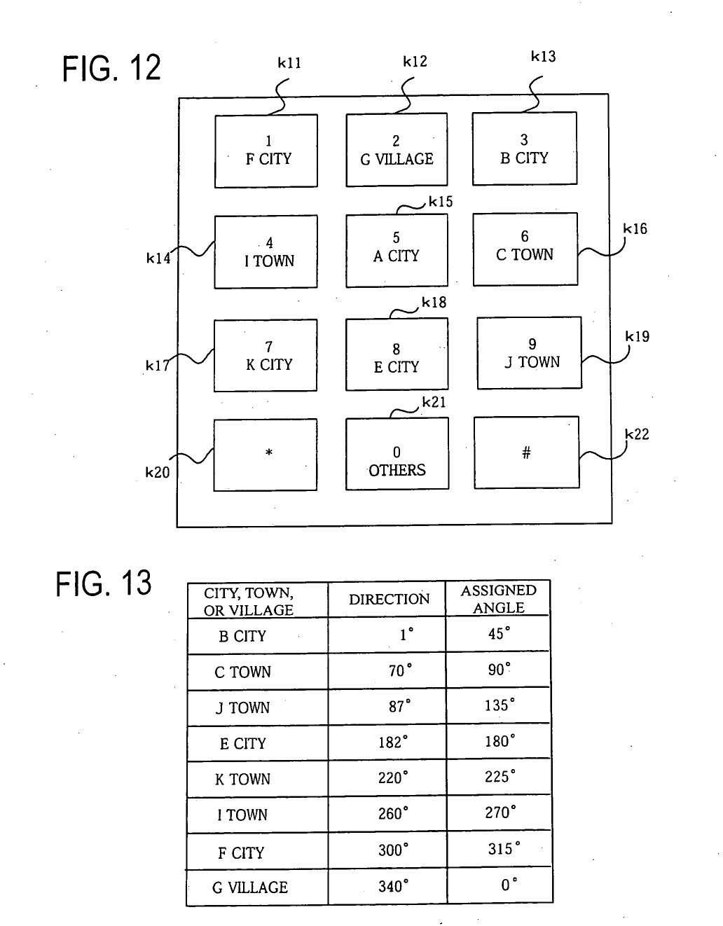

A second embodiment of the present invention is described below with reference to FIGS. 9-13. FIG. 9 is a flow chart showing a searching operation according to the second exemplary embodiment of the invention. FIG. 10 is a conceptual diagram showing actual locations of cities, towns, and villages, according to the second exemplary embodiment of the invention. FIG. 11 is a first diagram showing a button assignment process according to the second exemplary embodiment of the invention. FIG. 12 is a diagram showing an example of a search screen used in a narrow-area search according to the second exemplary embodiment of the invention. FIG. 13 is a second diagram showing a button assignment process according to the second exemplary embodiment of the invention.

If the user touches a particular selection area fj on the search screen di shown in FIGS. 3 to 5 to select the prefecture whose name is displayed in that selection area fj, the CPU 31 performs a wide-area search process to set the selected prefecture as a selected wide area.

The CPU 31 then determines whether a prefecture in which the vehicle is currently located has been selected (step S11). If it is determined that a prefecture in which the vehicle is currently located is not selected (S11=NO), a screen for use in inputting characters is formed on the display 35. In response, the user specifies a wide administrative district and a small administrate district by inputting characters indicating a city, a town, and/or a village (step S20).

On the other hand, if a prefecture in which the vehicle is currently located is selected (S11=YES), the CPU 31 performs an administrative district detection process to detect a city, a town, or a village (A city, in this specific example) in which the vehicle is currently located. Subsequently, the CPU 31 performs an adjacent administrative district detection process in which map data is read and adjacent cities, towns, and/or villages (B city, C town, D city, E city, F city, G village, H village, I town, J town, and K town, in this specific example) are selected (step S13).

The CPU 31 performs a specific facility search process. Specifically, the CPU 31 searches the facility data to detect administrative institution offices (denoted by open circles in FIG. 10) selected as specific facilities located in the selected adjacent cities, towns, and/or villages (step S14). The CPU 31 performs a specific facility evaluation process in which on the basis of the coordinates of the current position and the coordinates of the respective administrative institution offices, the search cost of a route from the current position to each of the administrative institution offices is calculated (step S15), and each administrative institution office is evaluated by using the calculated search cost as an evaluation measure. The CPU 31 reads the search data and determines a route from the current position to each administrative institution office. Thereafter, the CPU 31 calculates the cost of each route on the basis of a predetermined cost condition (the distance in the present embodiment), and employs the calculated cost as the search cost.

Next, the CPU 31 performs a selection process. First, the CPU 31 determines whether the number of adjacent cities, towns, and/or villages is equal to or smaller than, for example, eight (step S16). If the number of adjacent cities, towns, and/or villages is greater than eight (S16=NO), the CPU 31 selects eight adjacent cities, towns, and/or villages in the order of decreasing evaluation score obtained in the evaluation of the specific facilities, that is, in the order of increasing search cost (in this specific example, B cities, C towns, E cities, F cities, G village, I town, J town, and K town are selected) (step S17).

Subsequently, the CPU 31 performs a button assignment process as a selection area assignment process in which buttons k11 to k22 similar to telephone push buttons indicating “1” to “9”, “*”, “0”, and “#” are displayed on the narrow-area search screen as shown in FIG. 12. Buttons k11 to k19 are assigned as selection areas for selecting cities, towns, and/or villages on the basis of the search cost of the route to each administrative institution office (step S18).

The CPU 31 performs an order determination process in which the total of eight cities, towns, and/or villages are sorted in the order of increasing search cost as shown in FIG. 11 (in this specific example, the total of eight cities, towns, and villages are sorted into the order of E city, B city, I town, J town, C town, G village, F city, and K town).

Thereafter, the CPU 31 performs a direction calculation process. The direction αj (0=1, 2, . . . , 8) from the current position to each administrative institution office is calculated from the coordinates of the current position and the coordinates of each administrative institution office. In this process, the direction αj is expressed by an angle measured in a clockwise direction with respect to due north. In this specific example, as shown in FIG. 11, the directions αj of E city, B city, I town, J town, C town, G village, F city and K town are respectively calculated as 182, 1, 260, 87, 70, 340, 300, and 220 (in units of degrees).

In the present exemplary embodiment, a button k15 is assigned to represent a city, a town, or a village in which the vehicle is currently located, and eight buttons k11 to k14 and k16 to k19 are assigned to represent adjacent cities, towns, and/or villages. Eight buttons k11 to k14 and k16 to k19 located around the button k15 respectively have assigned angles βi (i=1, 2, . . . , 8) 0, 45, 90, 135, 180, 225, 270, and 315 (in units of degrees) indicating the positions of the respective buttons k11 to k14 and k16 to k19, wherein each direction βj is expressed by an angle measured in a clockwise direction with respect to due north.

Furthermore, the CPU 31 performs an assignment process. Specifically, the cities, towns, and/or villages are sorted in the order of increasing angle αj (3=1, 2, . . . , 8) calculated in the angle calculation process (in this specific example, the cities, town, and/or villages are sorted into the order of B city, C town, J town, E city, K town, I town, F city, and G village). An assigned angle βj is determined that is closest to the angle αj of each adjacent city, town, or village in the order of increasing search cost starting from a lowest search cost (in this specific example, E city has a lowest search cost), and a button having the determined assigned angle βj is assigned. If any assigned angle βj is used once, the same assigned angle βj is not used again, and an assigned angle βj closest to a next given direction αj is selected from the remaining assigned angles βj.

More specifically, in this example, the angle α4 of E city having the lowest search cost is 182°, and thus an assigned angle β4 of 180° closest to the angle of 182° is employed, and a button k18 is assigned to represent E city. The angle α5 of K town is 220°, and thus an assigned angle β5 of 225° closest to the angle of 220° is employed, and a button k17 is assigned to represent K town. The angle α6 of I town is 260°, and thus an assigned angle β6 of 270° closest to the angle of 260° is employed, and a button k14 is assigned to represent I town.

The angle α7 of F city is 300°, and thus an assigned angle β7 of 315° closest to the angle of 300° is employed, and a button k11 is assigned to represent F city. The angle α8 of G village is 340°, and thus an assigned angle β8 of 0° closest to the angle of 340° is employed, and a button k12 is assigned to represent G village.

The angle α1 of B city is 1°, and thus an assigned angle β1 of 45° closest to the angle of 1° is employed, and a button k13 is assigned to represent B city. The angle α2 of C town is 70°, and thus an assigned angle β2 of 90° closest to the angle of 70° is employed, and a button k16 is assigned to represent C town.

The angle α3 of J town is 87°, and thus an assigned angle β3 of 135° closest to the angle of 87° is employed, and a button k19 is assigned to represent J town.

If assignment of buttons to the respective cities, towns, and/or villages is completed, the search screen display means forms a narrow-area search screen on the display 35 as shown in FIG. 12 (step S19).

In this state, the user can select one of cities, towns, and/or villages whose name is displayed on corresponding buttons k11 to k19, by touching one of buttons k11 to k19 displayed on the search screen. If one of cities, towns, and/or villages is selected, the CPU 31 performs a narrow-area search process to set the city, town, or village, selected in the previous process, as a selected narrow area. If a remote controller is used as the operation control unit 34 (FIG. 1), one of the cities, towns, and/or villages whose name is displayed on corresponding buttons k11 to k19 can be selected by pressing an arrow key or a numeric key of the remote controller.

As described above, the buttons k11 to k19 on the search screen are assigned to cities, towns, and/or villages such that the positional relationship among the buttons k11 to k19 is similar to the actual positional relationship between a city, a town, or a village in which the vehicle is currently located and adjacent cities, towns, and/or villages, and thus the driver can easily recognize the positional relationship between the current position and a location to search for. This makes it possible to easily search for a location by an address.

Furthermore, because the buttons k11 to k19 for selecting a city, a town, or a village are laid out on the search screen in a similar manner to the manner in which telephone push buttons are laid out, it becomes possible to easily operate the operation control unit 34.

In the exemplary embodiments described above, the cost for each route is calculated on the basis of the distance, and the calculated cost is employed as the search cost. Alternatively, the cost may be calculated for each route on the basis of, for example, the road type, the road width, the number of lanes, and/or the number of traffic signals, and the calculated cost may be employed as the search cost.

In the embodiments described above, the administrative institution offices of each city, town, or village are evaluated by using the search cost as the evaluation measure, and cities, towns, and villages are sorted in the order of increasing searching cost. Alternatively, instead of the search cost, the distance from the current position to each administrative institution office, the population of each city, town, or village, or the area of each city, town, or village may be employed as the evaluation measure, and cities, towns, and/or villages may be sorted by the evaluation measure.

Furthermore, in the embodiments described above, selection areas fj are formed in the form of a matrix array on the wide-area search screen di. Alternatively, selection areas may be formed on the wide-area search screen such that they are laid out in a similar manner to the manner in which telephone push buttons are laid out, as with the narrow-area search screen shown in FIG. 7. In this case, for example, selection areas f1 to f9 shown in FIG. 3 are assigned to buttons k1 to k9 shown in FIG. 7.

In the present invention, as described in detail above, administrative districts located around the current position are displayed in selection areas on the search screen. The determination as to which administrative district is displayed in which selection area is made on the basis of the direction of each administrative district with respect to the current position such that the relative positional relationship among the selection areas becomes similar to the relative positional relationship to the actual positional relationship among an administrative district in which the current position is located and administrative districts adjacent to the administrative district in which the current position is located.

This makes it possible for the user to easily recognize the relative locations of adjacent administrative districts with respect to the location of the administrative district in which the current position is located, thereby making it possible for the user to easily search for a place by an address.

While various features of this invention have been described in conjunction with the exemplary embodiments outlined above, various alternatives, modifications, variations and/or improvements of those features may be possible. Accordingly, the exemplary embodiments of the invention, as set forth above, are intended to be illustrative. Various changes may be made without departing from the spirit and scope of the invention.

What is claimed is:

1. A navigation system, comprising:
a current position detector that detects a current position; and
at least one controller that:
determines an administrative district where the current position is located;
searches for at least one facility, each at least one facility located in a corresponding one of a plurality of administrative districts substantially adjacent to the administrative district where the current position is located; and
assigns each of the plurality of administrative districts substantially adjacent to the administrative district where the current position is located to a selection area on a search screen based on a direction from the current position to one of the at least one facilities within that one of the plurality of administrative districts substantially adjacent to the administrative district where the current position is located.

2. The navigation system of claim 1, wherein each selection area is associated with a predefined angle and the at least one controller assigns each of the plurality of administrative districts substantially adjacent to the administrative district where the current position is located to a selection area based on the predefined angles.

3. The navigation system of claim 1, wherein the at least one controller selects, for each administrative districts substantially adjacent to the administrative district where the current position is located, a specific one of the at least one facilities.

4. The navigation apparatus of claim 1, wherein the at least one controller searches for the at least one facility by selecting each one of the plurality of administrative districts substantially adjacent to the administrative district where the current position is located and then searching for the at least one facility located in that selected one of the plurality of administrative districts substantially adjacent to the administrative district where the current position is located.

5. The navigation system of claim 1, wherein the at least one controller evaluates each selected specific facility and assigns each of the plurality of administrative districts substantially adjacent to the administrative district where the current position is located to a selection area on the search screen based on the evaluation.

6. The navigation system of claim 5, wherein the at least one controller evaluates each selected specific facility based on a search cost of a route form the current position to that selected specific facility.

7. The navigation system of claim 6, wherein the at least one controller assigns each of the plurality of administrative districts substantially adjacent to the administrative district where the current position is located to a selection area in order of decreasing search cost, starting with the lowest search cost.

8. A navigation system comprising:
a current position detector that detects a current position; and
at least one controller that:
assigns buttons that are laid out in a manner substantially similar to the buttons of a telephone, each assigned button representing an administrative district where the current position is located and a plurality of administrative districts substantially adjacent to the administrative district where the current position is located.

9. A method for searching for a location, comprising:
determining a current position;
searching for at least one facility, each at least one facility located in a corresponding one of a plurality of administrative districts substantially adjacent to the administrative district where the current position is located; and
assigning each of the plurality of administrative districts substantially adjacent to the administrative district where the current position is located to a selection area on a search screen based on a direction from the current position to one of the at least one facilities within that one of the plurality of administrative districts substantially adjacent to the administrative district where the current position is located.

10. The method of claim 9, wherein assigning each of the plurality of administrative districts substantially adjacent to the administrative district where the current position is located to the selection area on the search screen based on the direction from the current position to the one of the at least one facilities within that one of the plurality of administrative districts substantially adjacent to the administrative district where the current position is located comprises assigning each of the plurality of administrative districts substantially adjacent to the administrative district where the current position is located to the selection area based on predefined angles associated with the selection areas.

11. The method of claim 9, further comprising selecting, for each administrative district substantially adjacent to the administrative district where the current position is located, a specific one of the at least one facilities.

12. The method of claim 9, wherein searching for at least one facility, each at least one facility located in a corresponding one of a plurality of administrative districts substantially adjacent to the administrative district where the current position is located comprises, for each one for each one of the plurality of administrative districts substantially adjacent to the administrative district where the current position is located:
selecting, that one of the plurality of administrative districts substantially adjacent to the administrative district where the current position is located; and
searching for the at least one facility located in that selected one of the plurality of administrative districts substantially adjacent to the administrative district where the current position is located.

13. The method of claim 9, wherein assigning each of the plurality of administrative districts substantially adjacent to the administrative district where the current position is located to the selection area on the search screen based on the direction from the current position to the one of the at least one facilities within that one of the plurality of administrative districts substantially adjacent to the administrative district where the current position is located comprises evaluating each selected specific facility and assigning each of the plurality of administrative districts substantially adjacent to the administrative district where the current position is located to the selection area on the search screen based on the evaluation.

14. The method of claim 13, wherein evaluating each selected specific facility and assigning each of the plurality of administrative districts substantially adjacent to the administrative district where the current position is located to the selection area on the search screen based on the evaluation comprises evaluating each selected specific facility based on the search cost of a route form the current position to that selected specific facility.

15. The method of claim 14, wherein assigning each of the plurality of administrative districts substantially adjacent to the administrative district where the current position is located to the selection area on the search screen based on the direction from the current position to the one of the at least one facilities within that one of the plurality of administrative districts substantially adjacent to the administrative district where the current position is located comprises assigning each of the plurality of administrative districts substantially adjacent to the administrative district where the current position is located to a selection area in order of decreasing search cost, starting with the lowest search cost.

16. A storage medium storing a set of program instructions executable on a data processing device and usable for searching for a location, the set of program instructions comprising:
instructions for determining a current position;
instructions for searching for at least one facility, each at least one facility located in a corresponding one of a plurality of administrative districts substantially adjacent to the administrative district where the current position is located; and
instructions for assigning each of the plurality of administrative districts substantially adjacent to the administrative district where the current position is located to a selection area on a search screen based on a direction from the current position to one of the at least one facilities within that one of the plurality of administrative districts substantially adjacent to the administrative district where the current position is located.
